(19) United States
(12) Patent Application Publication
(10) Pub. No.: US 2006/0124692 A1
(43) Pub. Date: Jun. 15, 2006

(54) Soldering machine

(75) Inventors: Rie Aizawa, Kanagawa-ken (JP); Hiroyuki Ota, Kanagawa-ken (JP); Hiroaki Abe, Kanagawa-ken (JP)

Correspondence Address: FOLEY AND LARDNER LLP;SUITE 500, 3000 K STREET NW, WASHINGTON, DC, 20007, US

(73) Assignee: KABUSHIKI KAISHA TOSHIBA

(21) Appl. No.: 11/349,175

(22) Filed: Feb. 8, 2006

Related U.S. Application Data
(63) Continuation of application No. 10/897,013, filed on Jul. 23, 2004.
Application No. 10/897,013 is a continuation of application No. 10/291,788, filed on Nov. 12, 2002, now abandoned.

(30) Foreign Application Priority Data
Nov. 12, 2001 (JP) 2001-345753

(51) Int. Cl. B23K 1/08

(52) U.S. Cl. 228/37

(57) ABSTRACT

A soldering machine includes a solder vessel, an electromagnetic pump, and a nozzle. The solder vessel stores molten solder, and the electromagnetic pump moves the solder by generating electromagnetic force. The electromagnetic pump is submerged below the liquid surface of the solder. The nozzle ejects the solder in the solder vessel onto an object, such as a printed circuit board. Accordingly, the generated heat from the electromagnetic pump is conducted to the solder in the solder vessel, and the solder can be heated to a higher temperature than in the conventional soldering machine.

The present application is a Continuation of U.S. application Ser. No. 10/897,013, filed Jul. 23, 2004, which is a Continuation of U.S. application Ser. No. 10/291,788, filed Nov. 12, 2002, the entire contents of which are incorporated herein by reference.

### BACKGROUND OF THE INVENTION

1. Field of the Invention

This invention relates to a soldering machine, and more particularly to a soldering machine used for a soldering process on the back side of a printed circuit board and the like, by ejecting pressurized molten solder thereon.

2. Description of the Related Art

Soldering machines are well known for soldering conductive lead wires of electronic parts onto a circuit pattern on a printed circuit board. Because molten solder is a kind of conducting fluid, an electromagnetic pump has been used to convey molten solder. For this reason, a soldering machine having an electromagnetic pump has been developed, such as disclosed in Japanese Patent Disclosure (Kokai) No. 58-122170, for example.

The electromagnetic pump in a conventional soldering machine has a solder vessel having an iron core and a outer duct to form a passage for molten solder. The other elements such as coils, a stator including most parts of the iron core, a stator support and the like, are disposed in the lower space below the solder vessel. Due to electromagnetic force generated by the coils and the electric current applied thereto, molten solder moves in the solder vessel and is ejected from nozzles onto a printed circuit board.

The conventional soldering machine using an electromagnetic pump, however, the coils receive heat from different heat sources; one is from the solder melt by the heater, and another is Joule heat generated by the coils themselves. Therefore, a cooling system, such as a fan, is necessary in view of heat resistivity of the coils.

Plus, according to an environmental point of view, replacing conventional solder with leadless solder, such as, an alloy containing Sn, Ag and Cu, for example, is widely demanded. In the case of applying the leadless solder, the melting point of the leadless solder is assumed to be higher, by approximately up to 50° C., in comparison with that of the conventional solder, which has a melting point of approximately 200° C. However, improving the performance of the heater to produce a higher temperature adversely affects the temperature of the coils of the electromagnetic pump.

### SUMMARY OF THE INVENTION

The present invention has been made in view of the above-mentioned circumstances and is intended to solve the above-mentioned problems. In particular, this invention provides a soldering machine capable of utilizing solder having a high melting point by improving the thermal balance thereof.

Additional object and advantages of the invention will be apparent to persons skilled in this field from the following description, or may be learned by practice of the application.

The present invention provides a soldering machine, including: a solder vessel that stores solder in the molten state, an electromagnetic pump mounted at a level to be submerged below the liquid surface of the solder for generating electromagnetic force to move the solder in the solder vessel, and a nozzle downstream of the electromagnetic pump that ejects the solder in the solder vessel onto an object to be soldered.

Further objects, features and advantages of the present invention will become apparent from the detailed description of embodiments that allows, when considered together with the accompanying figures of drawings.

### BRIEF DESCRIPTION OF THE DRAWINGS

In the drawings:

FIG. 1 is a diagrammatic view showing a soldering machine of the first embodiment.

FIG. 2 is a perspective sectional view showing an annular linear type electromagnetic pump applied to the soldering machine of the first embodiment.

FIG. 3 is another sectional view showing the annular linear type electromagnetic pump of the first embodiment.

FIG. 4 is a diagrammatic view showing an inner duct being removed from the electromagnetic pump.

FIG. 5 is a sectional view showing the connecting portion of an outer duct and an inner duct of the first embodiment.

FIG. 6 is a partial perspective view showing a locking structure of FIG. 5.

FIG. 7 is a diagrammatic view showing a soldering machine of the second embodiment.

FIGS. 8A and 8B are partial perspective views showing main portions of the stators of a flat linear type electromagnetic pump applied to the soldering machine of the second embodiment.

FIG. 9 is a sectional view showing an annular linear type electromagnetic pump applied to the soldering machine of the third embodiment.

FIG. 10 is a perspective view showing a helical type electromagnetic pump applied to the soldering machine of the fourth embodiment.

FIG. 11 is a diagrammatic sectional view showing a soldering machine of the fifth embodiment.

FIG. 12 is another diagrammatic sectional view showing a soldering machine of the fifth embodiment.

FIG. 13 is a diagrammatic sectional view showing annular linear type electromagnetic pumps applied to the soldering machine of the fifth embodiment.

### DETAILED DESCRIPTION OF PREFERRED EMBODIMENTS

Preferred embodiments of a soldering machine of the invention will now be specifically described in more detail with reference to the accompanying drawings. Wherever possible, the same reference numbers will be used throughout the drawings to refer to the same or like parts.

### First Embodiment

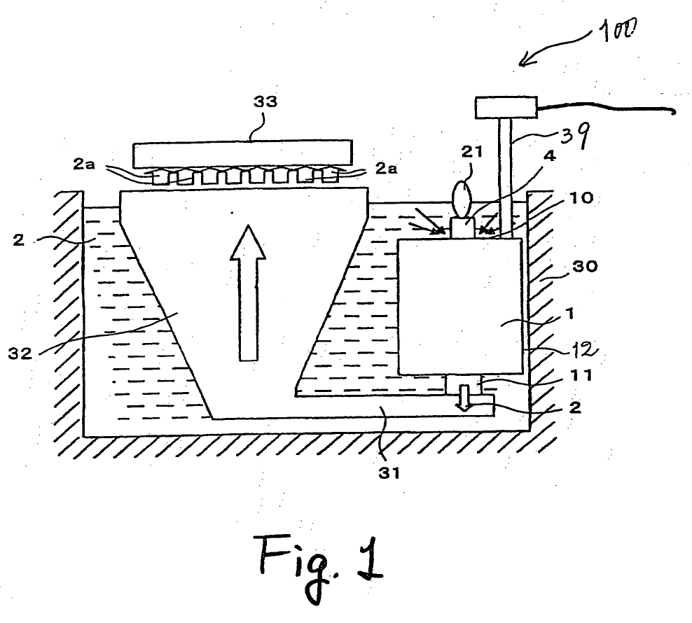

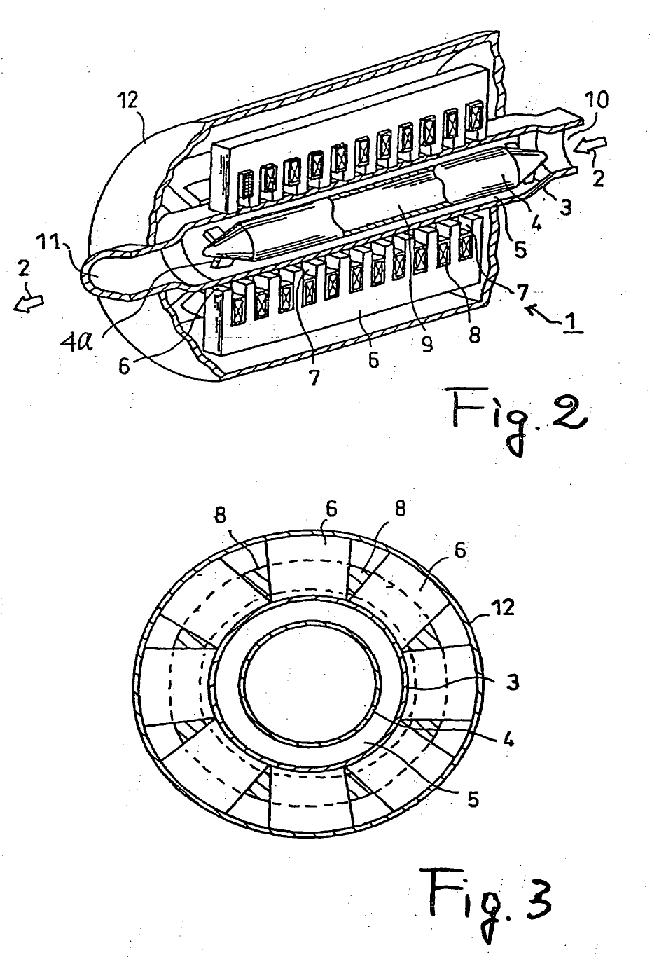

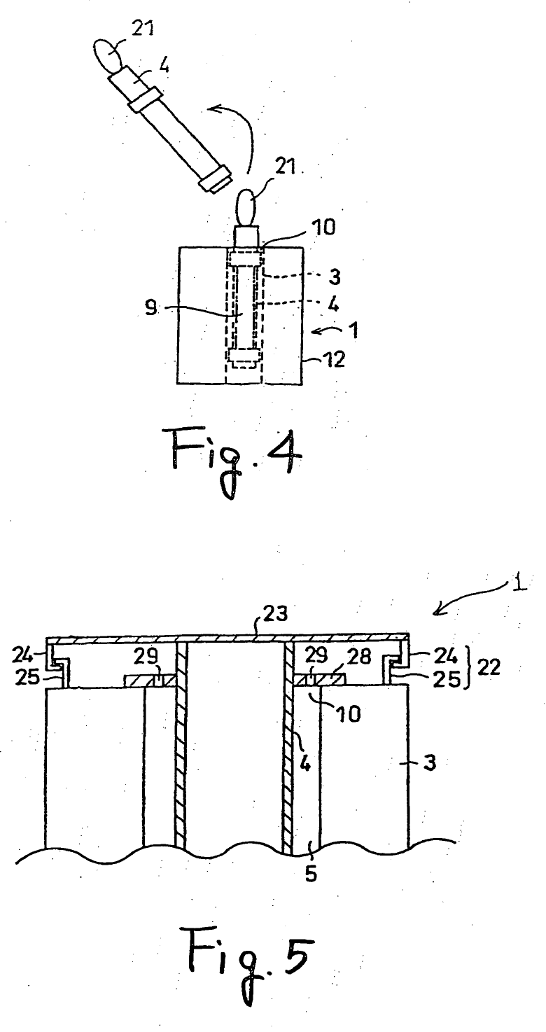

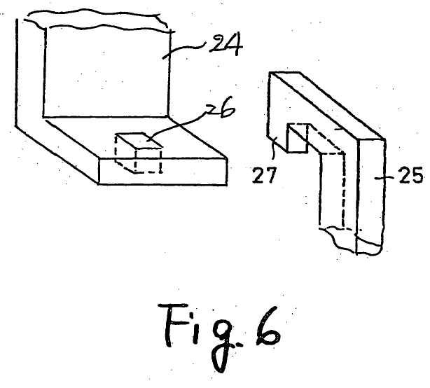

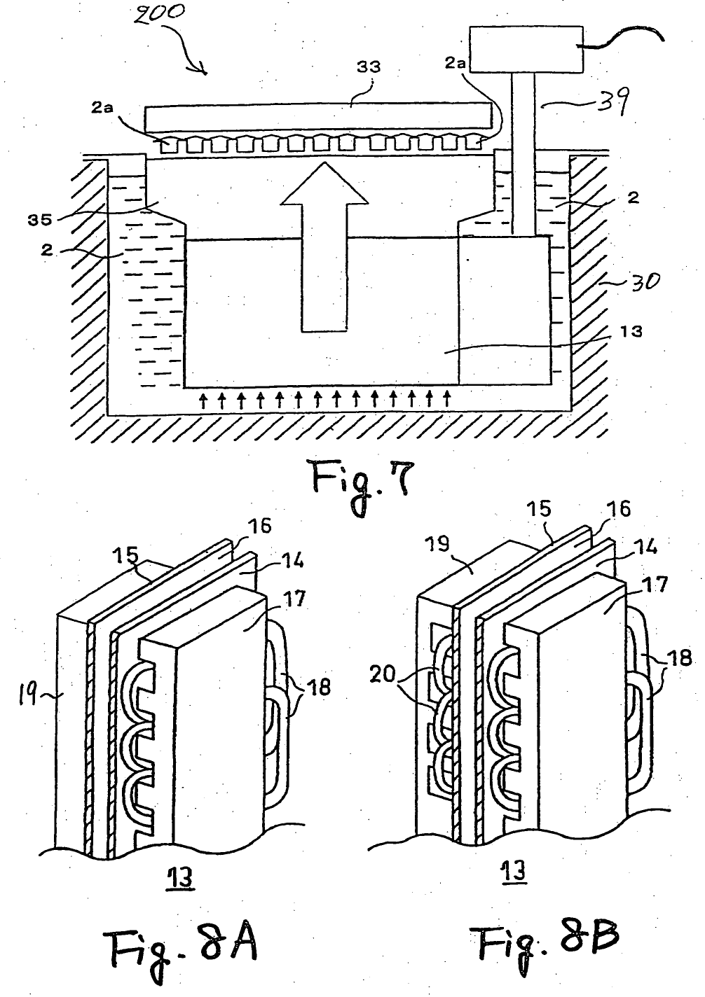

The first embodiment of the invention is shown in FIGS. 1, 2, 3 and 4. FIG. 1 is a diagram showing the soldering machine 100 of the first embodiment. FIG. 2 is a perspective sectional view, and FIG. 3 is another sectional view showing an annular linear type electromagnetic pump applied to the soldering machine 100 of the first embodiment. FIG. 4 is a diagram showing an inner duct being removed from the electromagnetic pump.

First, the movement of solder is explained as follows. In FIG. 1, a solder vessel 30 stores solder 2 in the molten state. The solder stored therein may be leadless solder, for example, and is heated by a conventional heater (not shown). In the solder vessel 30, an annular linear type electromagnetic pump 1 is disposed in the solder 2 such that the electromagnetic pump 1 is submerged below the liquid surface of solder 2.

Here, a pull-out ring 21 can be connected to an inner duct 4 of the electromagnetic pump 1 for extracting the inner duct 4 for overhaul. A cable conduit 39 is connected for supplying electrical power to the electromagnetic pump 1.

As shown in FIGS. 2 and 3, the electromagnetic pump 1 has an outer duct 3. The outer duct 3 has an entrance duct 10 and an exit duct 11 on both its ends. Together with the inner duct 4, the outer duct 3 forms an annular path 5 linearly along the center axis of the electromagnetic pump 1. Therefore, solder 2 introduced from the entrance duct 10 goes through the annular duct 5, and is emitted from the exit duct 11. The relative position of the outer duct 3 and the inner duct 4 is kept by projections 4a of the inner duct 4 by contacting the projections 4a to the outer duct 3. This means the sectional shape of the annular path 5 is kept constant.

The exit duct 11 guides solder to a nozzle 32 through a guide tube 31. The nozzle 32 has a plurality of spouting holes (not shown) on its exit, and faces an object to be soldered such as a printed circuit board 33. Therefore, solder 1 flowing the direction 2 shown by the arrow in the nozzle 32 is finally spouted 2a onto the printed circuit board 33.

The solder overflowing from the nozzle 32 returns to the solder vessel 30 again and is reused.

Next, the detailed structure of the electromagnetic pump 1 is explained as follows.

As shown in FIGS. 2 and 3, a plurality of outer iron cores (first iron cores) 6 are connected to surround the outside surface of the outer duct 3, and are arranged along the circumferential direction. Each outer iron core 6 is made of laminated electromagnetic plates formed like a comb.

The clearances, which are constituted by the comb-shape of the outer iron cores 6, are defined as slots 7, and are set in parallel along the axial direction of the outer duct 3. Ring-like outer electromagnetic coils 8 are disposed in the slots 7, and are connected to each other to generate a driving magnetic field by applying three-phase alternating current.

In the inner duct 4, an inner iron core (second iron core) 9 is disposed. The outer iron cores 6 and the inner iron core 9 act to generate magnetic field for moving solder, as well as to radiate Joule heat and the heat from the electromagnetic coils 8 to the molten solder 2.

Note that each electromagnetic plate may have holes to insert fixing parts. Therefore, the outer iron core 6 is manufactured such that the electromagnetic plates are laminated and then fixed together by the fixing parts. The electromagnetic plates of both sides of the outer iron core 6 may be chosen to maintain the lamination.

The outer iron cores 6 are surrounded by a casing 12 to seal those elements. Supporting structures (not shown) are disposed in the casing 12, and support each outer iron core 6 in a cantilevered fashion. For this reason, the outer iron cores 6 can be pressed against the outer duct 3.

The outer duct 3 and the casing 12 are made of nonmagnetic material. Preferably, the material is anti-corrosive against solder and flux as well as hard enough to withstand the high temperature of the solder 2.

The outer iron cores 6 and the inner iron core 9 are made of ferromagnetic material. The outer electromagnetic coils 8 are constituted by a combination of conductor and insulator; both the conductor and the insulator are anti-corrosive enough at the high temperature (approximately more than 250° C.) of the solder 2 and at the high temperature of Joule heat generated by the outer electromagnetic coils 8.

In case of cleaning the inside of the electromagnetic pump 1, the process can be carried out as shown in FIG. 4. First, the ring 21 is connected to the top portion of the inner duct 4 adjacent to the entrance duct 10. Then, the hooked ring 21 is pulled out to remove the inner duct 4 in the outer duct 3. Thereby, solder oxide stuck in the annular path 5, on the surface of the outer duct 3 and the inner duct 4, can be removed readily.

Here, the inner duct 4 may have a projection that comes up to the liquid level of the solder 2 in the solder vessel 30. By connecting the ring to the projection, the inner duct 4 can be removed easily.

In order to keep the sectional shape of the annular path 5 constant, the outer duct 3 and the inner duct 4 may be connected such as shown in FIG. 5. FIG. 5 shows a sectional view of the connecting portion of the outer duct 3 and the inner duct 4. The entrance side of the inner duct 4 extends past the edge of the outer duct 3, and is fixed to a plate 23. The plate 23 and the outer duct 3 are connected to each other via a locking structure 22. The locking structure 22 includes a hook 24 connected to the plate 23 and a hook 25 connected to the outer duct 3.

FIG. 6 is a partial perspective view showing one embodiment of the locking structure 22 of FIG. 5. The hook 24 of the plate 23 has a recess 26, while the hook 25 of the outer duct 3 has a projection or claw 27. By turning the plate 23, the claw 27 is hooked in the recess 26, and then the plate 23 is secured and locked.

Once the lock structure 22 operates, a flange 28 fixed on the inner duct 4 is pressed onto the end of the outer duct 3. Meanwhile, the inner duct 4 is lifted upward by buoyancy in the solder vessel 30. These forces are well balanced to keep the parts in locked relationship.

Note that solder 2 enters the annular path 5 through a plurality of holes 29 formed in the flange 28.

In case of removing the inner duct 4 from the outer duct 3, the plate 23 is turned in the other direction to unlock. These steps can be executed readily.

According to the first embodiment, the electromagnetic pump 1 of the soldering machine 100 is disposed in the solder vessel 30 and is submerged below the liquid surface of the solder 2. Therefore, the heat generated from the electromagnetic pump 1 can be conducted to the solder 2 in the solder vessel 30. Consequently, it is possible to heat the solder in the solder vessel to a higher temperature than in the conventional soldering machine. The capacity of the heater for melting the solder can be reduced accordingly.

This structure is also advantageous in applying leadless solder, because its melting point is approximately 50° C. higher than the conventional solder. If leadless solder is applied to the soldering machine 100, heat resistivity of the insulator used in the outer electromagnetic pump 1 may be considered. For this case, an insulator having enough heat resistivity at the melting point of leadless solder may be chosen. Thereby, the generated heat from the electromagnetic coils 8 can be conducted to the solder in the annular path 5 through the outer iron cores 6. This achieves a reduction of the cooling system in the casing 12.

In addition, by employing an annular linear type electromagnetic pump as the electromagnetic pump 1, the inner duct 4 can be removed from the electromagnetic pump 1. This simplifies the cleaning of the surface of the outer duct 3 and the inner duct 4; solder 2 in the annular path 5 leaves solder oxide on the outer duct 3 and the inner duct 4. Thereby, the sectional area of the annular path 5 can be constant, and fluctuation of the liquid level of the solder 2 in the solder vessel 30 can be limited.

As long as the electromagnetic pump 1 is submerged in the solder 2, any location and/or orientation of the electromagnetic pump 1 in the solder vessel 30 can be arbitrarily chosen. The axis of the electromagnetic pump 1 may be inclined in the solder vessel 30 or horizontal to the liquid level, for example.

### Second Embodiment

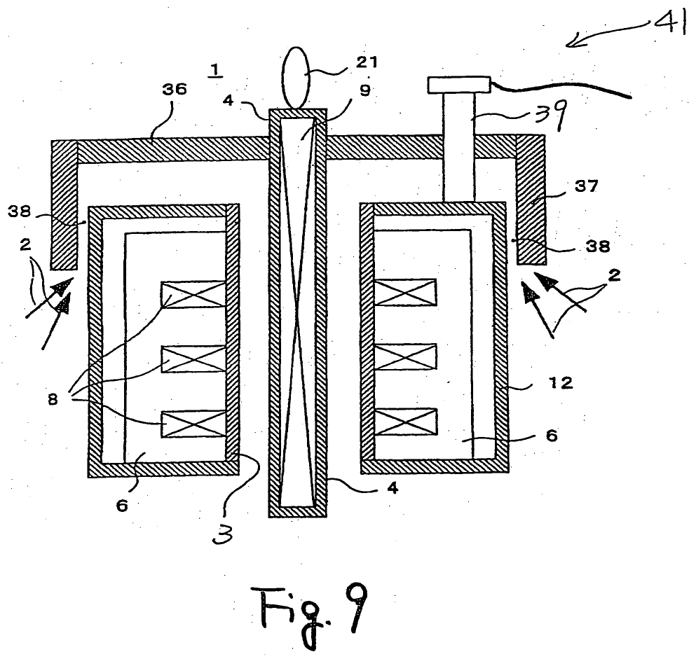

The second embodiment of the invention is shown in FIGS. 7, 8A and 8B. This embodiment employs a flat linear type electromagnetic pump 13, as shown in FIG. 7, in place of the annular linear type electromagnetic pump of the first embodiment.

FIGS. 8A and 8B are partial perspective views showing main portions of the stators of the flat linear type electromagnetic pump 13.

The electromagnetic pump 13 is submerged below the liquid surface of solder 2. A nozzle 35; having a rectangular shape, is connected downstream of the electromagnetic pump 13. The nozzle 35 faces the object 33 to be soldered.

As shown in FIG. 8A, the electromagnetic pump 13 has two plates, an inner plate (inner duct) 14 and an outer plate (outer duct) 15, facing each other in parallel. The gap bounded by the plates 14 and 15 is defined as a flow path 16 for solder 2. An outer iron core 17, connected to back surface of the outer plate 14, has outer electromagnetic coils 18 in its slots. An inner iron core 19 is connected to back surface of the inner plate 15. The outer electromagnetic coils 18 generate a driving magnetic field by applying three-phase alternating current.

Further, it is possible to constitute the electromagnetic pump 13 as shown in FIG. 8B. In this example, another iron core (inner iron core) 19 is connected to back surface of the inner plate 15. The inner iron core 19 has inner electromagnetic coils 20 in its slots. Although FIG. 8A shows single stator structure, FIG. 8B shows double stator structure.

The outer iron core 17 and the outer electromagnetic coils 18 are supported by supporting structures (not shown) and are stored in the casing 12.

Here, the outer plate 14, the inner plate 15 and the casing 12 are made of nonmagnetic material. Preferably, the material is anti-corrosive against solder and flux as well as hard enough to withstand the high temperature of the solder 2.

The outer iron core 17 is made of ferromagnetic material. The outer electromagnetic coils 18 are constituted by combination of conductor and insulator; both the conductor and the insulator are anti-corrosive enough of the high temperature (more than 250° C.) of the solder 2 and at the high temperature of Joule heat generated by the outer electromagnetic coils 18.

According to the second embodiment, the same advantages, as of the first embodiment can be achieved. That is, the electromagnetic pump 13 of the soldering machine 200 is disposed in the solder vessel 34 and is submerged below the liquid surface of the solder 2. Therefore, the heat generated from the electromagnetic pump 13 can be conducted to the solder 2 in the solder vessel 34. Consequently, the capacity of the heater for melting the solder can be reduced.

Moreover, the electromagnetic pump 13 has a rectangular flat shape. Therefore, the spatial efficiency in the solder vessel 30 can be improved if the solder vessel 30 is also rectangular.

Two plates, the outer plate 14 and the inner plate 15, are disposed in parallel to define a flow path in this embodiment; however, a single plates having a horseshoe shape or a rectangular inner space can be applied in place of the plates 14 and 15. These examples also derive the same effect as the above-explained embodiment.

Further, the solder 2 receives approximately, a double thrust by applying the double stator structure (FIG. 8B) to the electromagnetic pump 13, in comparison with the single stator structure (FIG. 8A).

### Third Embodiment

The third embodiment of the invention is shown in FIG. 9. In this embodiment, the basic structure of the electromagnetic pump 41 is the same as the electromagnetic pump 1 of the first embodiment.

Here, the plate 36 connected to the inner duct 4 is further equipped with a cylindrical flow skirt 37. Therefore, the upper space of the casing 12 is covered with the plate 36 and the flow skirt 37, except for a small gap 38. The flow skirt 37 acts to restrict the flow of the solder 2 adjacent to the flow path 5. The length of the flow skirt 37 in the axial direction is not of significance.

According to the third embodiment, solder oxide floating on the liquid surface of solder 2 in the solder vessel 30 can be collected by the plate 36 and the flow skirt 37. This can avoid solder oxide entering the annular path 5 of the electromagnetic pump 41, and therefore, fluctuation of the liquid level of solder 2 can be limited.

### Fourth Embodiment

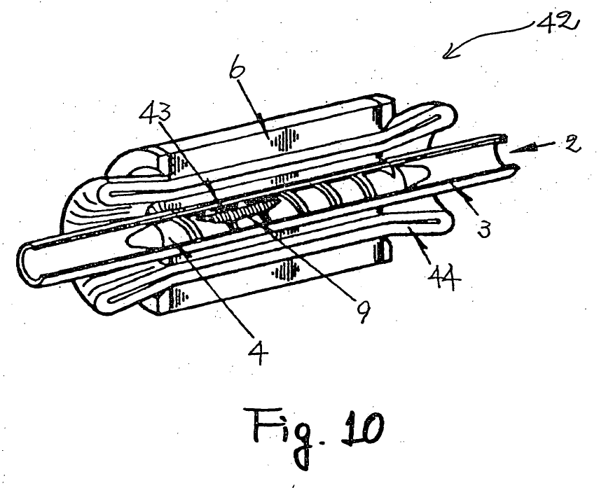

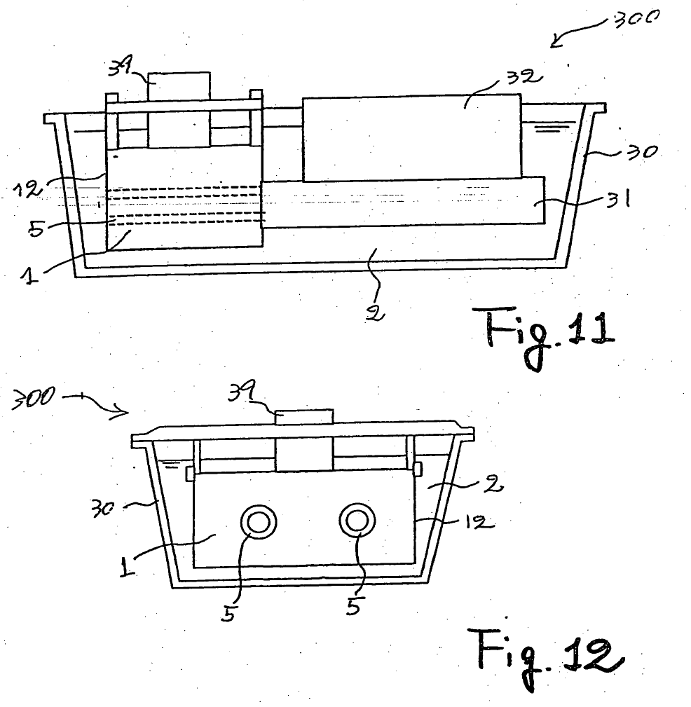

The fourth embodiment of the invention is shown in FIG. 10. In this embodiment, a helical type electromagnetic pump is employed. The overall structure of the soldering machine can be the same as of the above-explained embodiments.

As shown in FIG. 10, grooves 43 are formed on the inner duct 4 of the helical type electromagnetic pump 42. Molten solder 2 flows along the grooves 43 between the outer duct 3 and the inner duct 4.

Inner electromagnetic coils 44 are different from the electromagnetic coils 8 of the annular type electromagnetic pump 1 shown in FIG. 3; the winding directions thereof are set orthogonal to each other. This allows electromagnetic force to be generated in the circumferential direction of the inner duct 4. Solder 2 can be conveyed in the grooves 43 by turning the inner duct 4 around its axis.

In the case of using the electromagnetic pump 42 thus constituted, the same advantages as of the other embodiments are achieved.

### Fifth Embodiment

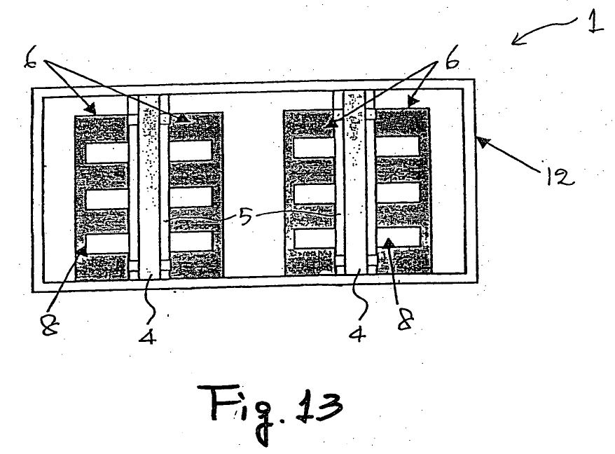

The fifth embodiment of the invention is shown in FIGS. 11, 12 and 13. In this embodiment, two annular linear type electromagnetic pumps 1 are employed in tandem in one solder vessel 12 of the soldering machine 300. The overall structure of the soldering machine can be the same as of the first embodiment. This structure can realize the benefit of sharing most elements while generating double the electromagnetic force.

As described above in detail, the present invention makes it possible to provide a soldering machine capable of utilizing solder having a higher melting point, by improving the thermal balance thereof.

The foregoing discussion discloses and describes merely a number of exemplary embodiments of the present invention. As will be understood by those skilled in the art, the present invention may be embodied in other specific forms without departing from the spirit or essential characteristics thereof.

Accordingly, the disclosure of the present invention is intended to be illustrative, but not limiting, of the scope of the invention, which is set forth in the following claims. Thus, the present invention may be embodied in various ways within the scope of the spirit of the invention.

The right of priority is claimed based on Japanese Patent Application 2001-345753, filed Nov. 12, 2001, and the entire contents thereof are incorporated herein by reference.

What is claimed is:

1. A soldering machine, comprising:
a solder vessel for containing solder in a molten state,
an electromagnetic pump mounted at a level to be submerged below the liquid surface of the solder for generating electromagnetic force to move the solder in the solder vessel, and
a nozzle downstream of the electromagnetic pump that ejects the solder in the solder vessel onto an object to be soldered.

2. The soldering machine according to claim 1 further comprising:
a casing enclosing the pump,
a flow path penetrating the casing for allowing solder therein,
a first iron core disposed in the casing and connected to the flow path, and
a coil connected to the iron core for generating electromagnetic force to move solder in the flow path.

3. The soldering machine according to claim 2, wherein the electromagnetic force generated by the coil circulates solder in the solder vessel.

4. The soldering machine according to claim 2, wherein the flow path comprises an annular-shaped section surrounded by the first iron core, and has a second iron core inserted therein.

5. The soldering machine according to claim 4, wherein the electromagnetic pump is an annular linear type electromagnetic pump.

6. The soldering machine according to claim 2, wherein the flow path comprises a rectangular shaped section bounded by the first iron core.

7. The soldering machine according to claim 6, wherein the electromagnetic pump comprises a flat linear type electromagnetic pump.

8. The soldering machine according to claim 2, wherein the flow path comprises an annular-shaped section surrounded by the first iron core, and a second iron core inserted therein, wherein a groove is formed around the second iron core.

9. The soldering machine according to claim 8, wherein the electromagnetic pump comprises a helical type electromagnetic pump.

10. The soldering machine according to claim 4, wherein the second iron core is selectively removable from the flow path.

11. The soldering machine according to claim 10, further comprising a locking structure for securing the second iron core to the plow path.

12. The soldering machine according to claim 1, further comprising a flow skirt disposed adjacent to the flow path for restricting the flow of solder.

13. The soldering machine according to claim 1, wherein the soldering machine is designed for containing leadless solder.
